(19) United States
(12) Patent Application Publication
(10) Pub. No.: US 2008/0148622 A1
(43) Pub. Date: Jun. 26, 2008

(54) Method and apparatus for self-illuminating fishing lures

(76) Inventor: Jeffery Luke Ashby, Payson, AZ (US)

Correspondence Address: WALLACE, LLC, P.O. BOX 1925, PAYSON, AZ, 85547, US

(21) Appl. No.: 12/043,064

(22) Filed: Mar. 5, 2008

(51) Int. Cl. A01K 85/01

(52) U.S. Cl. 43/17.6

(57) ABSTRACT

A method and apparatus for self-illuminating fishing lures is provided so as to increase visibility of the fishing lures to predator fish. Self-illumination is accomplished by chemiluminescence through the introduction of an activator solution, such as hydrogen peroxide, into a fluorescer solution. The color emitted by the fishing lure after chemiluminescent activation may be designed by appropriate selection of the fluorescer solution to create color selections across the red, orange, yellow, green, blue, indigo, and violet spectrum of visible light. Hard-body lures may accept either glow cartridges or glow packets that contain the activator and fluorescer solutions. Soft-body lures may accept cartridges, or may be injected with either activator solution or fluorescer solution to activate the chemiluminescent process. Soft-body lures may also contain the fluorescer solution and a vial containing the activator solution. The vial is then ruptured to mix the solutions causing emission of visible light from the lure.

### FIELD OF THE INVENTION

The present invention generally relates to fishing lures, and more particularly to self-illuminating fishing lures.

### BACKGROUND OF THE INVENTION

Ever since the existence of salt and fresh water species of fish has become known, mankind has been devising methods and instrumentalities to make harvesting of such fish more efficient and productive. While harvesting fish began as a method to obtain sustenance for man's survival, conventional fishing activities have substantially evolved into sport and commercially related activities. As such, while the commercial fishing activities continue to provide salt and fresh water species of fish for human consumption, sport fishing continues to evolve as an increasingly popular, non-commercial activity.

Whether the motivation to attract predator fish from fresh and/or salt water is sport or commercially based, the effectiveness and efficiency of the lures used for such attraction continues to be enhanced. In particular, efforts to increase visibility of fishing lures during periods of nightfall induced, or weather induced, darkness are of particular interest.

For example, nightfall or weather induced darkness may tend to attract predator fish closer to the water's surface and/or the water's edge. As such, predator fish become increasingly available for capture, but due to the challenging visual conditions, may remain elusive and generally uninterested in the fishing lures used during such periods of darkness. Similarly, predator fish at depth, even during full daylight conditions, experience equally challenging reduced visibility due to the refractive, dispersive, and reflective characteristics of either salt or fresh water.

Conventional methods previously used to counteract the visually challenging effects of darkness include the creation of artificial light in the target area. In particular, direct current (DC) based lighting may be applied in the target area, so that lures designed to be used during visually acceptable conditions may nevertheless be utilized during periods of darkness. Such methods include the attachment of light emitting instrumentalities directly to the fishing line that is used for the lure itself, or conversely, may utilize separate tethering mechanisms to create a periphery of light in the target area. Such lighting mechanisms, however, may present such an excessively artificial condition that the predator fish are repelled from, rather than attracted to, the lure.

Other methods used to increase the visibility of the lure during periods of darkness include utilizing the lure itself as the illuminating instrumentality. In particular, fishing lure manufacturers conventionally use zinc-based products in their fishing lures, such that when the fishing lures are exposed to ultra-violet (UV) radiation, they emanate visible light. Such zinc-based products, however, require a source of UV radiation, such as sunlight, blacklight, or fluorescent light to be used as the charging agent before the zinc-based products may be caused to emanate visible light. As such, zinc-based products may not lend themselves well to fishing operations that do not have access to such UV radiation sources.

Efforts continue, therefore, to develop self-illuminating fishing lures that are not dependent upon a source of UV radiation for activation. Furthermore, efforts continue to develop fishing lures that are not dependent upon a separate source of light to be visible.

### SUMMARY OF THE INVENTION

To overcome limitations in the prior art, and to overcome other limitations that will become apparent upon reading and understanding the present specification, various embodiments of the present invention disclose a method and apparatus for self-illuminating fishing lures that do not require a source of ultra-violet (UV) radiation for activation, nor do they require a separate source of light to be visible.

In accordance with one embodiment of the invention, a self-illuminating fishing lure comprises a casing that is shaped in the form of prey. The casing includes one or more cavities that are adapted to accept a fluorescer solution and an activator solution. The one or more cavities emanate visible light from the self-illuminating fishing lure in response to mixing of the fluorescer solution and the activator solution within the one or more cavities.

In accordance with another embodiment of the invention, a fishing lure comprises at least one cavity, the at least one cavity being filled with a first solution. The fishing lure further comprises at least one injection port that is adapted to accept a second solution. The fishing lure further comprises at least one channel coupled to the at least one injection port and the at least one cavity. The second solution is propagated to the at least one cavity via the at least one channel to mix the first solution with the second solution to cause emanation of visible light from the at least one cavity.

In accordance with another embodiment of the invention, a method of emitting visible light from a fishing lure comprises mixing first and second solutions to create visible light and emitting the visible light from within a cavity of the fishing lure.

### BRIEF DESCRIPTION OF THE DRAWINGS

Various aspects and advantages of the invention will become apparent upon review of the following detailed description and upon reference to the drawings in which:

FIG. 1 illustrates a hinged, hard-body fishing lure that accepts a glow cartridge in accordance with one embodiment of the present invention;

FIG. 2 illustrates the self-illuminated, hard-body fishing lure of FIG. 1 after insertion of an activated glow cartridge in accordance with one embodiment of the present invention;

FIG. 3 illustrates a soft-body fishing lure that accepts a glow activation solution in accordance with one embodiment of the present invention;

FIG. 4 illustrates the self-illuminated soft-body fishing lure of FIG. 3 after acceptance of the glow activation solution in accordance with one embodiment of the present invention;

FIG. 5 illustrates a soft-body fishing lure that accepts a glow activation solution in specific regions of the soft-body fishing lure in accordance with one embodiment of the present invention;

FIG. 6 illustrates the self-illuminated soft-body fishing lure of FIG. 5 after acceptance of the glow activation solution in specific regions of the soft-body fishing lure in accordance with one embodiment of the present invention;

FIG. 7 illustrates a soft-body fishing lure that accepts a glow activation solution in specific regions of the soft-body fishing lure using alternate injection means in accordance with one embodiment of the present invention;

FIG. 8 illustrates the self-illuminated soft-body fishing lure of FIG. 7 after acceptance of the glow activation solution in specific regions of the soft-body fishing lure using alternate injection means in accordance with one embodiment of the present invention;

FIG. 9 illustrates a hinged, hard-body fishing lure that accepts a glow packet in accordance with one embodiment of the present invention;

FIG. 10 illustrates the self-illuminated, hard-body fishing lure of FIG. 9 after insertion of an activated glow packet in accordance with one embodiment of the present invention;

FIG. 11 illustrates an exemplary use of a self-illuminated fishing lure in accordance with various embodiments of the present invention;

FIG. 12 illustrates a soft-body fishing lure that self-contains both the fluorescer solution and the activator solution in accordance with an alternate embodiment of the present invention;

FIG. 13 illustrates the soft-body fishing lure of FIG. 12 after the self-contained fluorescer solution is activated by the self-contained activator solution; and

FIG. 14 illustrates a method of activating self-illuminating fishing lures in accordance with various embodiments of the present invention.

### DETAILED DESCRIPTION

Generally, various embodiments of the present invention are applied to the field of fishing lures, shaped in the form of prey, whereby activation of the fishing lures in accordance with the various embodiments of the present invention causes the fishing lures to emanate visible light. As such, the fishing lures become illuminated to make the prey shaped fishing lures become more visible and attractive to predator fish. Furthermore, activating the luminescence of the self-illuminating fishing lures does not require any form of ultra-violate (UV) radiation, nor do the self-illuminating fishing lures require a separate source of light to be visible at the target depth.

Instead, chemiluminescence may be utilized within the fishing lures to cause emission of visible light from within one or more cavities of the fishing lures. Chemiluminescence is caused by the reaction in the liquid phase of an activator solution, e.g., hydrogen peroxide, with a fluorescer solution, such as the combination of a fluorescent agent, an oxalate, and a soluble perylene dye. Additional fluorescent agents may also be added to the fluorescer solution to modify the characteristics of the emitted light.

Such activator and fluorescer solutions are non-toxic and are described in U.S. Pat. Nos. 4,678,608, 4,717,511, 5,122,306, and 5,232,635 and are incorporated herein by reference in their entirety. The color and intensity of light that is emitted by the fishing lure after chemiluminescent activation may be designed by appropriate selection of the fluorescer solution to create a wide variety of color selections across the red, orange, yellow, green, blue, indigo, and violet spectrum of visible light.

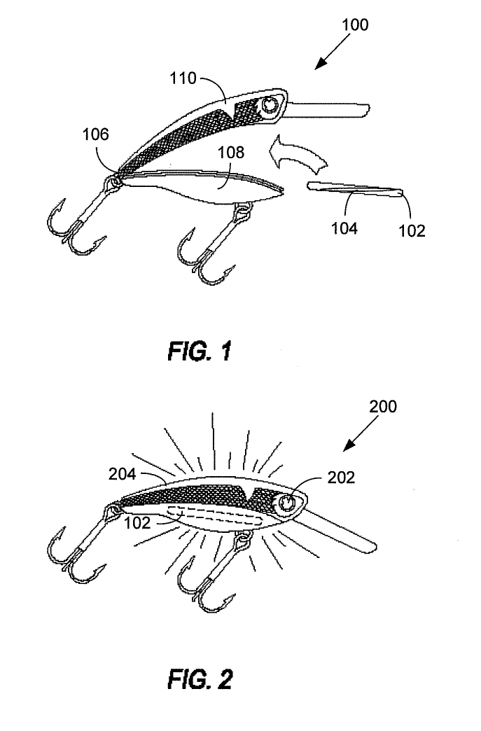

Turning to FIG. 1, hard-body fishing lure 100 is exemplified. Fishing lure 100 is implemented with hinged member 106, so that upper portion 110 may be separated from lower portion 108. In so doing, an inner cavity within fishing lure 100 is exposed to accept glow cartridge 102.

Glow cartridge 102 may contain a fluorescer solution, as well as vial 104 that may contain an activator solution. Prior to activation, the fluorescer solution is kept separate from the activator solution by operation of vial 104. The outer casing of glow cartridge 102 may be composed of a flexible plastic material, so as to allow manipulation of glow cartridge 102 to rupture vial 104. Once vial 104 is ruptured, the activator solution contained within vial 104 is released into the fluorescer solution, which then causes the emission of visible light by the process of chemiluminescence as discussed above.

Glow cartridge 102 may then be inserted into the inner cavity of fishing lure 100, as illustrated, and locked into place by engaging upper portion 110 with lower portion 108 via hinged member 106 as illustrated in FIG. 2. The rigid casing of fishing lure 200 may be constructed using a transparent, or sufficiently translucent, composition so as to allow the emission of light from within the inner cavity of fishing lure 200 by glow cartridge 102. As discussed above, the color of light emitted from within fishing lure 200 may be designed by appropriate selection of the fluorescer solution contained within glow cartridge 102.

In alternate embodiments, the light emitted by glow cartridge 102 may include all visible spectrums of light, so that the color of light emitted by glow cartridge 102 is white. In such instances, fishing lure 200 may be covered with a transparent, or sufficiently translucent, coating that is tinted in accordance with the color of light that is desired to be emitted by fishing lure 200. Accordingly, multiple luminescent effects and colors may be emitted by fishing lure 200 of FIG. 2 upon activation of glow cartridge 102.

A yellow coating, for example, may be used to coat eye portions 202 of fishing lure 200, whereas a red coating, for example, may be used to coat body portions 204 of fishing lure 200. As such, a two-tone illumination may be caused to exist within fishing lure 200, whereby eye portions 202 are caused to emit yellow light, while body portions 204 are caused to emit red light in response to the chemiluminescence of glow cartridge 102.

It is noted that virtually any color scheme and design may be used to produce the desired results based upon the predator fish that may be desired and the depth at which the predator fish are being lured. While the color and intensity of light emanating from within fishing lure 200 may be perfectly acceptable at the water's surface, the color of light emitted by fishing lure 200 may become unacceptable while at the target depth. For example, once the lure has descended to the target depth, the color of light emitted by fishing lure 200 may be visible to the predator fish only as various shades of grey due to the refractive, dispersive, and reflective characteristics of salt or fresh water at depth.

Thus, appropriate color and intensity modifications may be made depending upon the target depth being utilized and the predator fish being lured. Bass, walleye, pike, salmon, trout, steelhead, and many other species of fish, for example, have vision that is optimized for color selection. As such, by locating the predator fish using a depth finder and by combining the depth information with known color preferences of a particular species of predator fish, the most efficient color scheme and color design may be implemented using glow cartridge 102 and/or the various color combinations of fishing lure 200.

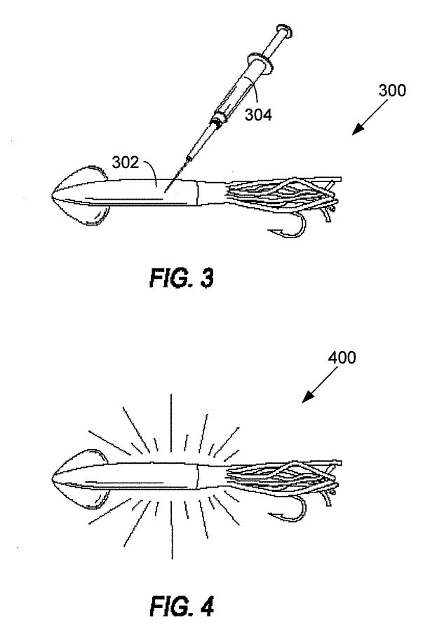

Turning to FIG. 3, an alternate embodiment of fishing lure 300 is exemplified, whereby a soft-body lure is used instead of the hard-body lure of FIGS. 1 and 2. In such an instance, body portion 302 of fishing lure 300 may be pre-filled with a fluorescer solution. Chemiluminescent activation occurs when an activator solution is injected into the fluorescer solution using syringe 304. Once activated, fishing lure 400 of FIG. 4 begins to emanate visible light in a color spectrum that is designed by appropriate selection of the fluorescer solution and/or skin color of fishing lure 400.

In alternate embodiments, body portion 302 of fishing lure 300 may be fabricated using a semi-solid core that does not contain a hollow cavity. Instead, a subcutaneous layer (not shown) existing between the skin layer of body portion 302 and the semi-solid core (not shown) of body portion 302 may be pre-filled with a fluorescer solution. In such an instance, syringe 304 is utilized to inject the activator solution into the fluorescer solution of the subcutaneous layer to activate the emission of visible light through chemiluminescence from fishing lure 400.

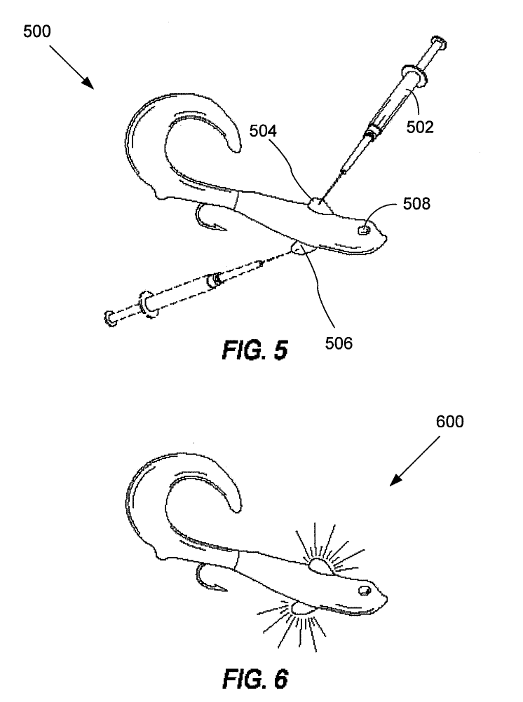

Turning to FIG. 5, an alternate embodiment of a fishing lure is illustrated, whereby only specific portions of the lure may be illuminated and other portions of the lure may remain non-luminescent. In particular, not only may various colors be emanated by chemiluminescent fishing lure 500, but glow effects in specific portions of the lure may also be created. For example, fins 504 and 506 of fishing lure 500 may be pre-filled with a fluorescer solution. An activator solution may then be injected into fins 504 and 506 so as to activate the chemiluminescence of fishing lure 600 as illustrated in FIG. 6.

In alternate embodiments, a single injection port (not shown) may be provided within fishing lure 500, so that a single injection of an activator solution may cause various portions of the fishing lure to glow. In such an instance, channels (not shown) may be created within fishing lure 500 to allow propagation of the activator solution from the single injection port into various sections, or cavities, of fishing lure 500 that are pre-filled with a fluorescer solution. Once injected with an activator solution via the single injection port, various sections, or cavities, of fishing lure 500, such as fins 504 and 506, may then begin to glow by chemiluminescence using the single injection of activator solution. It should be noted that the injection ports are one-way injection ports, which allow injection of solution, but prevent solution from escaping the fishing lure once injected.

In other embodiments, multiple injection ports may be individually utilized to activate chemiluminescence of separate portions of the fishing lure. For example, a first injection port (not shown) may be utilized to inject an activator solution into eye portions 508 that have been pre-filled with a first fluorescer solution to cause eye portions 508 to glow red, for example, after activation. A second injection port (not shown) may then be utilized to inject an activator solution into fins 504 and 506 that have been pre-filled with a second fluorescer solution to cause fins 504 and 506 to glow orange, for example, after activation.

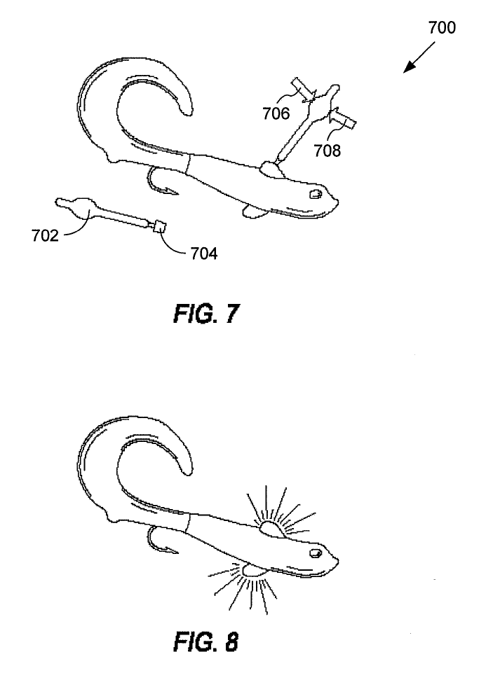

Turning to FIG. 7, an alternate embodiment is illustrated, whereby instead of a syringe, a flexible vial is used to inject the activator solution. In particular, flexible vial 702 may be pre-filled with an activator solution and capped using cap member 704. Cap member 704 may be removed from flexible vial 702 prior to insertion of flexible vial 702 into the injection port of fishing lure 700. Applying pressure in directions 706 and 708 upon flexible vial 702 causes the activator solution contained within vial 702 to be injected into fishing lure 700. Channels (not shown) within fishing lure 700 may then direct the activator solution to specific portions of fishing lure 700 that have been pre-filled with a fluorescer solution to cause those specific portions to glow as illustrated in FIG. 8.

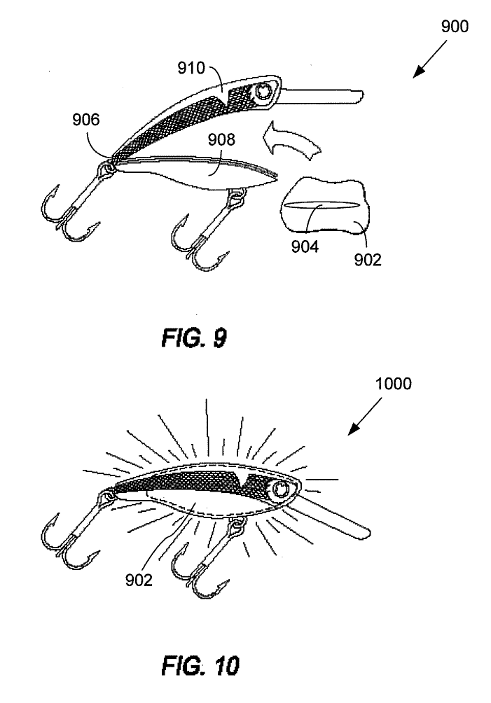

Turning to FIG. 9, an alternate embodiment is illustrated, whereby instead of a glow cartridge, a glow packet is used to create self-illumination. Fishing lure 900 is implemented with hinged member 906, so that upper portion 910 may be separated from lower portion 908. In so doing, an inner cavity within fishing lure 900 is exposed to accept glow packet 902.

Glow packet 902 may contain a fluorescer solution as well as vial 904 that contains an activator solution. Prior to activation, the fluorescer solution is kept separate from the activator solution by operation of vial 904. The outer casing of glow packet 902 may be composed of a highly flexible plastic material, so as to allow manipulation of glow packet 902 to rupture vial 904. Once vial 904 is ruptured, the activator solution contained within vial 904 is released into the fluorescer solution, which then causes the emission of visible light by the process of chemiluminescence as discussed above.

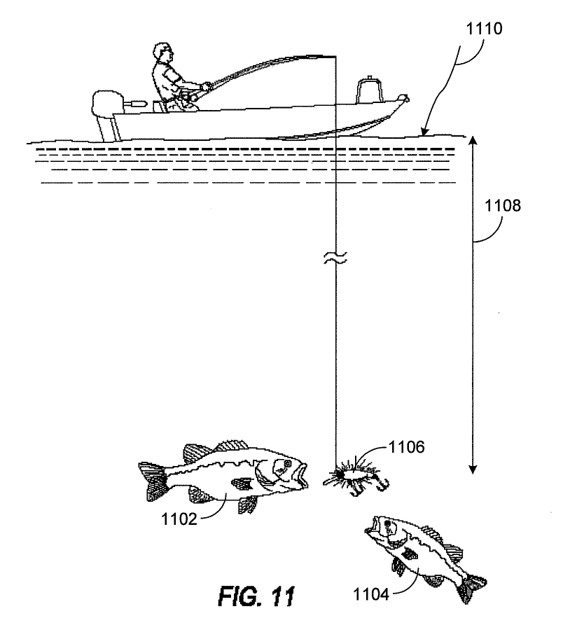

Glow packet 902 may then be used to line the inner cavity of fishing lure 900 so as to produce emanation of light from the entire surface of the inner cavity as illustrated in FIG. 10. Glow packet 902 may then be locked into place by engaging upper portion 910 with lower portion 908 via hinged member 906 as illustrated. The rigid casing of fishing lure 1000 may be constructed using a transparent, or sufficiently translucent, composition so as to allow the emission of light from within the inner cavity of fishing lure 1000 by glow packet 902. As discussed above, the color of light emitted from within fishing lure 1000 may be designed by appropriate selection of fluorescer solution contained within glow packet 902 and/or appropriate selection of the color used to coat the outer surface of fishing lure 1000.

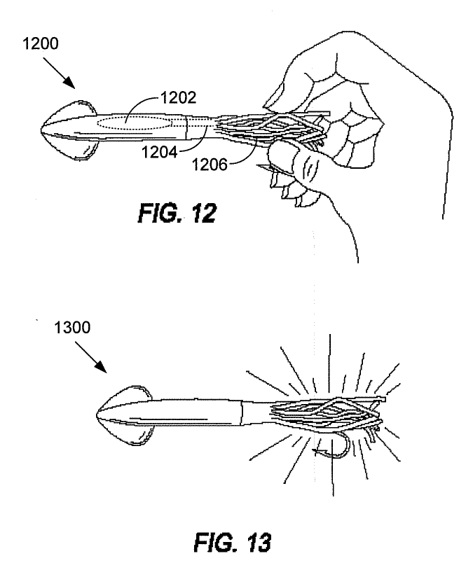

Turning to FIG. 11, one embodiment of the use of the self-illuminating lures as discussed above in relation to FIGS. 1-10, and as discussed below in relation to FIGS. 12-13, is exemplified. The separation distance that exists between predator fish 1102-1104 and self-illuminating lure 1106 may help to determine the color and design of light that is emitted from self-illuminating lure 1106 at depth 1108. For example, the efficiency which light propagates through water is inversely proportional to the wavelength of the light being propagated. That is to say, in other words, that red colored light has a wavelength that is on the order of 650 nm, but is able to propagate a relatively short distance before becoming visible only as various shades of grey. Violet light, on the other hand, has a wavelength that is on the order of 400 nm and is able to propagate longer distances before becoming visible only as various shades of grey.

Appropriate color modifications, therefore, may be determined based upon target depth 1108 and the types of predator fish 1102-1104 that are being targeted. Bass, walleye, pike, salmon, trout, steelhead, and many other species of fish, for example, have vision that is optimized for color selection. As such, by locating predator fish 1102-1104 using a depth finder and by combining the depth information with known color preferences of the particular species of predator fish being targeted, the most efficient color scheme and color design may be implemented. Such color modifications may be similarly made when targeting predator fish, such as tuna, halibut, swordfish, shark, etc., in deep sea applications.

In addition, glow effects may be introduced into the self-illuminating lures by selecting different glow colors to be emanated from different sections of the lure. For example, the body portion of the lure may be caused to emanate a first color spectrum of light to increase the contrast between the lure and its surroundings, so as to allow the predator fish to easily locate, track, and attack the lure. Second and third color spectrums of light, on the other hand, may be utilized to add further contrast to the lure, such as to highlight the fins and/or eyes of the lure.

Turning to FIG. 12, an alternate embodiment of a self-illuminating lure is exemplified. In particular, soft-body fishing lure 1200 may be pre-filled with a fluorescer solution and may also contain vial 1202 that may be filled with an activator solution. Upon manipulation of the flexible body of fishing lure 1200, vial 1202 is caused to be ruptured. The activator solution from vial 1202 then flows into the fluorescer solution contained within, e.g., tentacle portion 1206, via channel 1204 to cause tentacle portion 1206 of soft-body fishing lure 1300 to self-illuminate, as illustrated in FIG. 13, by chemiluminescence as discussed above.

It should be noted that any other portion of soft-body lure 1200 may be caused to self-illuminate as well. In such instances, one or more channels 1204 may be implemented within soft-body lure 1200 to direct activator solution to one or more sections, or cavities, of soft-body lure 1200 that have been pre-filled with fluorescer solution. The activator solution from vial 1202 then flows into the fluorescer solution contained within the various sections of soft-body lure 1200 via the one or more channels to cause the various sections of soft-body lure 1200 to self-illuminate.

In an alternate embodiment, soft-body fishing lure 1200 is not filled with either of a fluorescer or an activator solution. Instead, soft-body fishing lure 1200 provides a cavity that accepts a glow cartridge as discussed above in relation to glow cartridge 102 of FIG. 1. Glow cartridge 102 may contain a fluorescer solution, as well as vial 104 that may contain an activator solution. Prior to activation, the fluorescer solution is kept separate from the activator solution by operation of vial 104. The outer casing of glow cartridge 102 may be composed of a flexible plastic material, so as to allow manipulation of glow cartridge 102 to rupture vial 104. Once vial 104 is ruptured, the activator solution contained within vial 104 is released into the fluorescer solution, which then causes the emission of visible light by the process of chemiluminescence as discussed above. Glow cartridge 102 may then be inserted into the inner cavity of fishing lure 1200. As discussed above, the color of light emitted from within fishing lure 1200 may be designed by appropriate selection of the fluorescer solution contained within glow cartridge 102.

In alternate embodiments, the activator solution injection methods described in relation to FIGS. 3-8 may be modified so as to inject fluorescer solution, instead of activator solution, into the one or more sections, or cavities, of the respective fishing lures. In other words, one or more injection ports may be used to individually inject fluorescer solution into the one or more sections, or cavities, of the fishing lures that have been pre-filled with activator solution. In such instances, syringes 304, 502, or vials 702 may contain the appropriate fluorescer solution to create the desired color. As such, a variety of vials and/or syringes containing a corresponding variety of fluorescer solution selections may be kept on hand, so as to facilitate color experimentation within the self-illuminating lures.

That is to say, in other words, that various color modifications, as discussed above in relation to FIG. 11, may be implemented within self-illuminating lures 1106 to select the appropriate colors based upon target depth 1108 and the types of predator fish 1102-1104 that are being targeted. By locating predator fish 1102-1104 using a depth finder and by combining the depth information with known color preferences of the particular species of predator fish being targeted, the correct color may be selected through experimentation.

If a first illumination color caused by injection of a first fluorescer solution into a first fishing lure is not particularly successful, for example, then a second illumination color caused by injection of a second fluorescer solution into a second fishing lure may be used instead. It can be seen, therefore, that by maintaining a selection of self-illuminating fishing lures and a corresponding set of syringes/vials, where each syringe/vial contains a different fluorescer solution, that the appropriate fishing lure and the appropriate color selections may be obtained to maximize fishing efficiency and production.

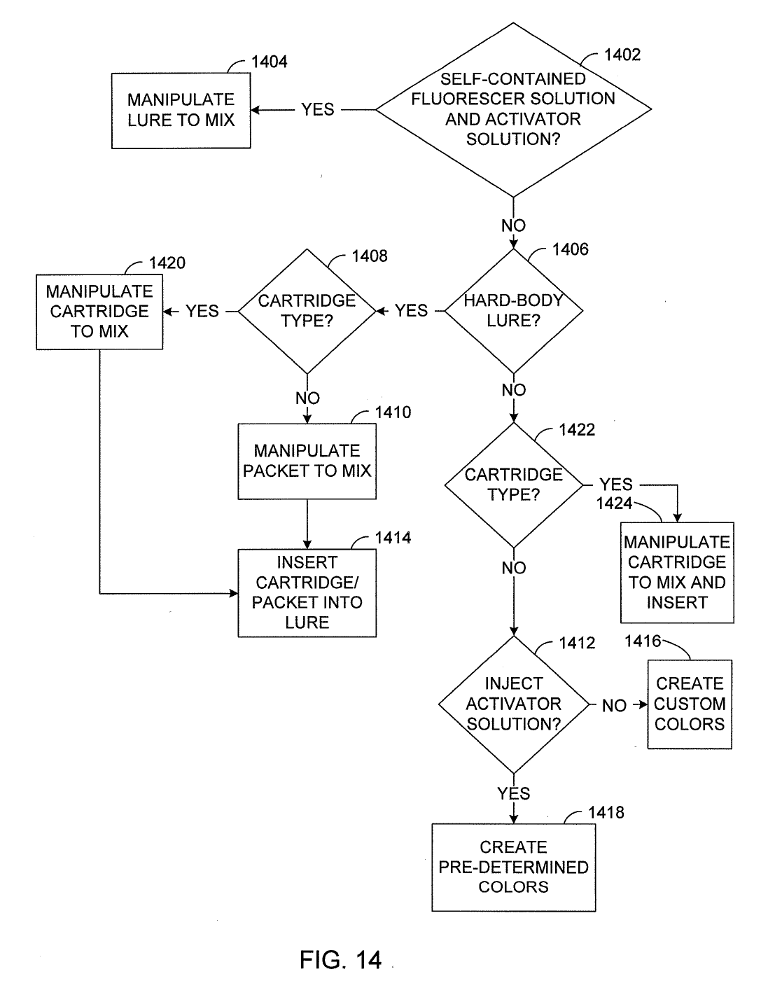

Turning to FIG. 14, a flow chart illustrating a method of activating self-illuminating fishing lures is exemplified. In step 1402, a determination is made as to whether the self-illuminating lure already contains the fluorescer solution, as well as the activator solution, as discussed above in relation to FIGS. 12 and 13. If so, the flexible, soft-body of fishing lure 1200 may be manipulated in step 1404 so as to rupture vial 1202. The activator solution from vial 1202 then mixes with the fluorescer solution contained within, e.g., tentacle portion 1206, via channel 1204 to cause tentacle portion 1206 of soft-body fishing lure 1300 to self-illuminate as illustrated in FIG. 13 by chemiluminescence as discussed above.

It should be noted that any other portion of soft-body lure 1200 may be caused to self-illuminate as well. In such instances, one or more channels 1204 may be implemented within soft-body lure 1200 to direct activator solution to one or more sections, or cavities, of soft-body lure 1200 that have been pre-filled with fluorescer solution. The activator solution from vial 1202 then mixes with the fluorescer solution contained within the various sections of soft-body lure 1200 via the one or more channels to cause the various sections of soft-body lure 1200 to self-illuminate.

If the lure to be activated does not already contain the fluorescer solution and the activator solution, then a determination is made in step 1406 as to whether the self-illuminating lure is hard-bodied. If the lure is soft-bodied, then a glow cartridge, as discussed above in relation to FIGS. 1 and 2, is selected in step 1422 and manipulated to mix the fluorescer and activator solutions to cause the cartridge to emit visible light as in step 1424. The cartridge may then be inserted in step 1424 into the cavity of the soft-body fishing lure to cause the soft-body fishing lure to emit visible light.

If a hard-body lure is used, on the other hand, then either a glow cartridge, as discussed above in relation to FIGS. 1-2, or a glow packet, as discussed above in relation to FIGS. 9-10, is utilized. If a glow cartridge is used, as determined in step 1408, then glow cartridge 102 containing a fluorescer solution and vial 104, that contains an activator solution, is utilized. Prior to activation, the fluorescer solution is kept separate from the activator solution by operation of vial 104. The outer casing of glow cartridge 102 may be composed of a flexible plastic material, so as to allow manipulation of glow cartridge 102 to rupture vial 104 as in step 1420. Once vial 104 is ruptured, the activator solution contained within vial 104 is mixed with the fluorescer solution, which then causes the emission of visible light by the process of chemiluminescence as discussed above.

Glow cartridge 102 may then be inserted into the inner cavity of fishing lure 100, as in step 1414, and locked into place by engaging upper portion 110 with lower portion 108 via hinged member 106 as illustrated in FIG. 2. The rigid casing of fishing lure 200 may be constructed using a transparent, or sufficiently translucent, composition so as to allow the emission of light from within the inner cavity of fishing lure 200 by glow cartridge 102. As discussed above, the color of light emitted from within fishing lure 200 may be designed by appropriate selection of the fluorescer solution contained within glow cartridge 102 and/or appropriate selection of the color used to coat the outer surface of fishing lure 200.

If a glow packet is used, on the other hand, then glow packet 902, containing a fluorescer solution, as well as vial 904, containing an activator solution, is utilized. Prior to activation, the fluorescer solution is kept separate from the activator solution by operation of vial 904. The outer casing of glow packet 902 may be composed of a highly flexible plastic material, so as to allow manipulation of glow packet 902 to rupture vial 904 as in step 1410. Once vial 904 is ruptured, the activator solution contained within vial 904 mixes with the fluorescer solution, which then causes the emission of visible light by the process of chemiluminescence as discussed above.

Glow packet 902 may then be used to line the inner cavity of fishing lure 900, as in step 1414, to produce emanation of light from the entire surface of the inner cavity as illustrated in FIG. 10. Glow packet 902 may then be locked into place by engaging upper portion 910 with lower portion 908 via hinged member 906. The rigid casing of fishing lure 1000 may be constructed using a transparent, or sufficiently translucent, composition so as to allow the emission of light from within the inner cavity of fishing lure 1000 by glow packet 902. As discussed above, the color of light emitted from within fishing lure 1000 may be designed by appropriate selection of fluorescer solution contained within glow packet 902 and/or appropriate selection of the color used to coat the outer surface of fishing lure 1000.

Conversely, if non-cartridge type, soft-body fishing lures are being utilized, then injection of either the fluorescer solution, or the activator solution, is performed to activate the chemiluminescence. If the activator solution is injected, as determined in step 1412, then chemiluminescence of pre-determined colors is performed in step 1418, since the fluorescer solution already exists within the soft-body lure, as discussed above in relation to FIGS. 3-8.

If fluorescer solution is injected instead of the activator solution, then chemiluminescence of custom colors may be performed as in step 1416. In particular, one or more injection ports may be used to individually inject fluorescer solution into the one or more sections of the fishing lures that have been pre-filled with activator solution. In such instances, syringes 304, 502, or vials 702 may contain appropriate fluorescer solution to create the desired color. As such, a variety of syringes/vials containing a corresponding variety of fluorescer solution selections may be kept on hand, so as to facilitate color experimentation within the self-illuminating lures to optimize performance under the prevailing circumstances.

Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A self-illuminating fishing lure, comprising:
a casing shaped in the form of prey, the casing including,
one or more cavities adapted to accept a fluorescer solution and an activator solution; and
wherein the one or more cavities emanate visible light from the self-illuminating fishing lure in response to mixing of the fluorescer solution and the activator solution within the one or more cavities.

2. The self-illuminating fishing lure of claim 1, wherein the one or more cavities contains the fluorescer solution and a vial containing the activator solution.

3. The self-illuminating fishing lure of claim 2, wherein the casing is flexible to allow manipulation of the vial, the vial being ruptured through manipulation to mix the fluorescer solution and the activator solution.

4. The self-illuminating fishing lure of claim 1, wherein the casing is adapted to allow insertion of a cartridge containing the fluorescer solution and a vial containing the activator solution.

5. The self-illuminating fishing lure of claim 1, wherein the one or more cavities are filled with the fluorescer solution.

6. The self-illuminating fishing lure of claim 5, wherein the one or more cavities are injected with the activator solution to mix the fluorescer solution and the activator solution.

7. The self-illuminating fishing lure of claim 1, wherein the one or more cavities are filled with the activator solution.

8. The self-illuminating fishing lure of claim 7, wherein the one or more cavities are injected with the fluorescer solution to mix the fluorescer solution and the activator solution.

9. The self-illuminating fishing lure of claim 1, wherein the casing includes a top portion, a bottom portion, and a hinged member coupled to the top and bottom portions.

10. The self-illuminating fishing lure of claim 9, wherein the top and bottom portions are separated via the hinged member to insert a cartridge containing the fluorescer solution and the activator solution.

11. The self-illuminating fishing lure of claim 9, wherein the top and bottom portions are separated via the hinged member to insert a packet containing the fluorescer solution and the activator solution.

12. A fishing lure, comprising:
at least one cavity, the at least one cavity being filled with a first solution;
at least one injection port adapted to accept a second solution;
at least one channel coupled to the at least one injection port and the at least one cavity; and
wherein the second solution is propagated to the at least one cavity via the at least one channel to mix the first solution with the second solution to cause emanation of visible light from the at least one cavity.

13. The fishing lure of claim 12, wherein the first solution includes a fluorescer solution and the second solution includes an activator solution that is injected into the at least one cavity via the at least one injection port.

14. The fishing lure of claim 12, wherein the first solution includes an activator solution and the second solution includes a fluorescer solution that is injected into the at least one cavity via the at least one injection port.

15. A method of emitting visible light from a fishing lure, the method comprising:
mixing first and second solutions to create visible light; and
emitting the visible light from within a cavity of the fishing lure.

16. The method of claim 15, wherein mixing first and second solutions comprises:
filling the cavity with an activator solution; and
injecting the cavity with a fluorescer solution.

17. The method of claim 15, wherein mixing first and second solutions comprises:
filling the cavity with a fluorescer solution; and
injecting the cavity with an activator solution.

18. The method of claim 15, wherein mixing the first and second solutions comprises:
filling the cavity with a fluorescer solution;
inserting a vial containing an activator solution into the cavity; and
rupturing the vial to release the activator solution into the fluorescer solution.

19. The method of claim 15, wherein mixing first and second solutions comprises:
filling a cartridge with a fluorescer solution and a vial containing an activator solution;
manipulating the cartridge to rupture the vial to mix the fluorescer and activator solutions within the cartridge; and
wherein the cartridge is inserted into the cavity.

20. The method of claim 15, wherein mixing first and second solutions comprises:
filling a packet with a fluorescer solution and a vial containing an activator solution;
manipulating the packet to rupture the vial to mix the fluorescer and activator solutions within the packet; and
wherein the packet is inserted into the cavity.
